(19) United States
(12) Patent Application Publication
(10) Pub. No.: US 2026/0180453 A1
(43) Pub. Date: Jun. 25, 2026

(54) DRIVE CIRCUIT AND PIEZOELECTRIC ACTUATOR

(71) Applicant: REALMAGIC SEMICONDUCTORS (SHENZHEN) CO., LTD., Shenzhen, Guangdong (CN)

(72) Inventors: Tong LIU, Shenzhen, Guangdong (CN); Rui YE, Shenzhen, Guangdong (CN); Jing HAN, Shenzhen, Guangdong (CN)

(21) Appl. No.: 18/849,239

(22) PCT Filed: Dec. 27, 2022
(86) PCT No.: PCT/CN2022/142440

§ 371 Date: Sep. 20, 2024

(30) Foreign Application Priority Data
Mar. 21, 2022 (CN) 202220621092.5

(51) Int. Cl. H02M 3/158; H02M 1/08; H02M 1/32; H02M 7/5387

(52) U.S. Cl. CPC H02M 3/1588; H02M 1/08; H02M 1/32; H02M 3/158; H02M 3/1582; H02M 3/1584; H02M 7/5387

(57) ABSTRACT

A drive circuit and a piezoelectric actuator. The drive circuit includes: a buck-boost circuit configured to operate in a corresponding voltage regulation mode according to a control signal for voltage regulation, to convert an input voltage into an unipolar folded signal and output the folded signal; a full-bridge inverter circuit configured to invert polarities of part of the folded signal according to a polarity inversion signal, so as to expand the folded signal into a target drive signal and output the target drive signal; and a control circuit configured to generate the control signal for voltage regulation and the polarity inversion signal according to a reference signal. The buck-boost circuit may output the unipolar folded signal according to the control signal for voltage regulation without adding an additional compensation circuit, and finally output the target drive signal through the full-bridge inverter circuit.

### CROSS-REFERENCE TO RELATED APPLICATIONS

This application is a 35 U.S.C. § 371 national stage application of PCT patent application No. PCT/CN2022/142440, filed on Dec. 27, 2022, which claims priority to Chinese patent application No. 202220621092.5, filed on Mar. 21, 2022, and entitled “drive circuit and piezoelectric actuator”, the entire contents each of which are incorporated herein by reference.

### TECHNICAL FIELD

The present application relates to the technical field of electronic circuits, and more particularly, to a drive circuit and a piezoelectric actuator.

### BACKGROUND

Nowadays, more and more applications in tactile feedback are provided. For example, a tactile effect on a wearable device such as a smartwatch and a sports wristband, is very important for a user, selection of a high-quality tactile engine is indispensable for improving user satisfaction. However, the main actuators (i.e., linear motor and rotor motor) for a small scale wearable device are generally limited by the sizes thereof, if a high performance is required, a large size is required. However, a small device has constrained space, and a bad haptic effect is finally generated. A piezoelectric actuator which uses a piezoelectric ceramic as an actuating component to implement tactile feedback has the advantages of high response speed, wide driving frequency band, great vibration intensity, fine and real feeling of vibration, small acoustic noise, low power consumption, small size and the like, and may be widely applied to devices with low power consumption and limited space to realize high-quality tactile feedback. However, the existing piezoelectric actuator has the problems such as high driving voltage (100-200VPP), high control difficulty of driving waveform and response speed, and the like.

With regard to the driving of piezoelectric actuators, a switching amplifier is a promising alternative solution that achieves relatively efficient, small size, and low weight. A switching power combines a passive element with an active semiconductor switch to transfer energy between a power supply and a load frequently and efficiently, and is most suitable for implementing a miniaturized circuit. The existing bidirectional buck-boost circuit may only boost voltage when being operated in a forward direction, which means that, an output must be greater than an input. When the output is lower than an output of an input voltage, an additional compensation operation needs to be performed.

### SUMMARY

An objective of the present application is providing a drive circuit and a piezoelectric actuator, which aims at solving a technical problem that the drive circuit of the conventional piezoelectric actuator can only boost voltage.

A drive circuit is provided in accordance with the first aspect of the embodiments of the present application. The drive circuit includes: a buck-boost circuit configured to operate in a corresponding voltage regulation mode according to a control signal for voltage regulation, so as to convert an input voltage into an unipolar folded signal and output the folded signal, the voltage regulation mode includes a forward boost mode, a reverse boost mode, a forward buck mode, and a reverse buck mode; a full-bridge inverter circuit connected to the buck-boost circuit and configured to invert polarities of part of the folded signal according to a polarity inversion signal, in order to expand the folded signal into a target drive signal and output the target drive signal; and a control circuit connected to the buck-boost circuit and the full-bridge inverter circuit and configured to generate the control signal for voltage regulation and the polarity inversion signal according to a reference signal, wherein the reference signal corresponds to the target drive signal.

In one embodiment, the buck-boost circuit includes a first switching transistor, a second switching transistor, a third switching transistor, a fourth switching transistor and a first inductor. A first conductive terminal of the first switching transistor is connected to an input positive electrode of the buck-boost circuit, a second conductive terminal of the first switching transistor is connected to a first conductive terminal of the second switching transistor, and a second conductive terminal of the second switching transistor is connected to an input negative electrode of the buck-boost circuit. Both the input positive electrode and the input negative electrode are configured to receive the input voltage. A first conductive terminal of the third switching transistor is connected to an output positive electrode of the buck-boost circuit, a second conductive terminal of the third switching transistor is connected to a first conductive terminal of the fourth switching transistor, and a second conductive terminal of the fourth switching transistor is connected to an output negative electrode of the buck-boost circuit. Control terminals of the first switching transistor, the second switching transistor, the third switching transistor and the fourth switching transistor are connected in common to the control circuit, in order to receive the control signal for voltage regulation. The first inductor is connected between the second conductive terminal of the first switching transistor and the second conductive terminal of the third switching transistor. The input negative electrode is connected to the output negative electrode.

In one embodiment, the buck-boost circuit further includes a first capacitor connected between the output positive electrode and the output negative electrode.

In one embodiment, when the buck-boost circuit is operated in the forward boost mode and the reverse buck mode according to the control signal for voltage regulation, the first switching transistor remains in a switched-on state, the second switching transistor remains in a switched-off state, the third switching transistor and the fourth switching transistor are complementarily switched-on.

In one embodiment, when the buck-boost circuit operates in the forward buck mode and the reverse boost mode according to the control signal for voltage regulation, the first switching transistor and the second switching transistor are complementarily switched-on, the third switching transistor remains in a switched-on state, and the fourth switching transistor remains in a switched-off state.

In one embodiment, the full-bridge inverter circuit includes a fifth switching transistor, a sixth switching transistor, a seventh switching transistor and an eighth switching transistor. A first conductive terminal of the fifth switching transistor is connected to the output positive electrode of the buck-boost circuit, a second conductive terminal of the fifth switching transistor is connected to a first conductive terminal of the sixth switching transistor and is further connected to a first load terminal, and a second conductive terminal of the sixth switching transistor is connected to the output negative electrode of the buck-boost circuit. A first conductive terminal of the seventh switching transistor is connected to the output positive electrode of the buck-boost circuit, a second conductive terminal of the seventh switching transistor is connected to a first conductive terminal of the eighth switching transistor and is connected to a second load terminal, and a second conductive terminal of the eighth switching transistor is connected to the output negative electrode of the buck-boost circuit. Control terminals of the fifth switching transistor, the sixth switching transistor, the seventh switching transistor, and the eighth switching transistor are connected in common to the control circuit, in order to receive the polarity inversion signal. The first load terminal and the second load terminal are configured to output the target drive signal.

In one embodiment, the control circuit includes a sampling subcircuit and a control subcircuit which are interconnected. The sampling subcircuit is connected to the buck-boost circuit, and is configured to collect the folded signal and a sampling current flowing through the buck-boost circuit, and output the folded signal and the sampling current to the control subcircuit. The control subcircuit is connected to the buck-boost circuit and the full-bridge inverter circuit, and is configured to generate the control signal for voltage regulation and the polarity inversion signal according to the reference signal, and perform a feedback control on the control signal for voltage regulation and the polarity inversion signal according to the folded signal and the sampling current. The control signal for voltage regulation and the polarity inversion signal are configured to respectively control a corresponding switching transistor to be switched-on or be switched-off.

In one embodiment, the buck-boost circuit includes a second inductor, a third inductor, a ninth switching transistor, a tenth switching transistor, a second capacitor, and a third capacitor. The second inductor, the second capacitor and the third inductor are sequentially connected in series between an input positive electrode of the buck-boost circuit and an output positive electrode of the buck-boost circuit. A first conductive terminal of the ninth switching transistor is connected to a first end of the second inductor, and a second conductive terminal of the ninth switching transistor is connected to an input negative electrode of the buck-boost circuit. A first conductive terminal of the tenth switching transistor is connected to a second end of the second inductor, and a second conductive terminal of the tenth switching transistor is connected to an output negative electrode of the buck-boost circuit. The third capacitor is connected between the output positive electrode and the output negative electrode, and the output negative electrode is connected to the input negative electrode.

In one embodiment, the buck-boost circuit includes a fourth inductor, a fifth inductor, an eleventh switching transistor, a twelfth switching transistor, a fourth capacitor, and a fifth capacitor. The fourth inductor is connected between a first conductive terminal of the eleventh switching transistor and an input positive electrode of the buck-boost circuit, and a second conductive terminal of the eleventh switching transistor is connected to an input negative electrode of the buck-boost circuit. A first conductive terminal of the twelfth switching transistor is connected to an output positive electrode of the buck-boost circuit, a second conductive terminal of the twelfth switching transistor is connected to the first conductive terminal of the eleventh switching transistor, and the fifth inductor is connected between the second conductive terminal of the twelfth switching transistor and an output negative electrode of the buck-boost circuit. The fourth capacitor is connected between the input negative electrode and the output negative electrode, and the fifth capacitor is connected between the output positive electrode and the output negative electrode.

A piezoelectric actuator is provided in accordance with the second aspect of the embodiments of the present application. The piezoelectric actuator includes an actuator circuit and the aforesaid drive circuit. The full-bridge inverter circuit is connected to the actuator circuit, and the actuator circuit is a capacitive actuator.

As compared to the related art, the embodiments of the present application have the following beneficial effects: the aforesaid buck-boost circuit has multiple voltage modulation modes, and may output an unipolar folded signal according to the control signal for voltage regulation without adding an additional compensation circuit, and finally outputs the target drive signal through the full-bridge inverter circuit.

### BRIEF DESCRIPTION OF THE DRAWINGS

FIG. 1 illustrates a principle diagram of a drive circuit provided in the first embodiment of the present application;

FIG. 2 illustrates a circuit configuration of the drive circuit provided in the first embodiment of the present application;

FIG. 3 illustrates a principle diagram of a control circuit provided in the first embodiment of the present application;

FIG. 4 illustrates a diagram of a signal waveform of an embodiment of the present application;

FIG. 5 illustrates a circuit configuration of the drive circuit provided in the second embodiment of the present application;

FIG. 6 illustrates a circuit configuration of the drive circuit provided in the third embodiment of the present application;

FIG. 7 illustrates a circuit configuration of a piezoelectric actuator provided in the fourth embodiment of the present application.

### DETAILED DESCRIPTION OF EMBODIMENTS

In order to make the technical problems, the technical solutions and the beneficial effects of the present application be clearer and more understandable, the present application will be further described in detail below with reference to the accompanying figures and the embodiments. It should be understood that the embodiments described herein are only intended to illustrate but not to limit the present application.

It needs to be noted that, when describing that one component is “fixed to” or “arranged on” another component, this component may be directly or indirectly arranged on another component. When describing that one component “is connected with” another component, this component may be directly or indirectly connected to the another component.

In addition, terms “the first” and “the second” are only used for description purposes, and should not be considered as indicating or implying any relative importance, or implicitly indicating the number of indicated technical features. As such, technical feature(s) restricted by “the first” or “the second” can explicitly or implicitly comprise one or more such technical feature(s). In the description of the present application, “a plurality of” has the meaning of two or more, unless there is additional explicit and specific limitation.

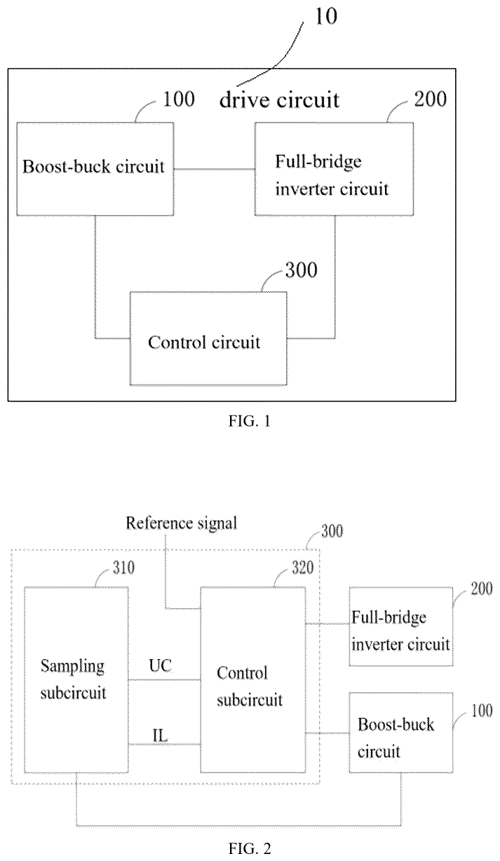

FIG. 1 illustrates a principle diagram of a drive circuit 10 according to the first embodiment of the present application. For the convenience of illustration, the part associated with the first embodiment is merely illustrated.

A drive circuit 10 includes a buck-boost circuit 100, a full-bridge inverter circuit 200, and a control circuit 300. The buck-boost circuit 100 is configured to operate in a corresponding voltage regulation mode according to a control signal for voltage regulation, so as to convert an input voltage UI into an unipolar folded signal UC and output the unipolar folded signal UC. The voltage regulation mode includes a forward boost mode, a reverse boost mode, a forward buck mode, and a reverse buck mode. The full-bridge inverter circuit 200 is connected to the buck-boost circuit 100 and is configured to reverse polarities of part of the folded signal UC according to a polarity inversion signal, so as to expand the folded signal UC into a target drive signal UO and output the target drive signal UO. The control circuit 300 is connected to the buck-boost circuit 100 and the full-bridge inverter circuit 200, and is configured to generate the control signal for voltage regulation and the polarity inversion signal according to the reference signal. The reference signal corresponds to the target drive signal UO.

The aforesaid buck-boost circuit 100 has a plurality of voltage modulation modes, and may increase or reduce the input voltage UI according to the control signal for voltage regulation without adding an additional compensation circuit, so as to output the unipolar folded signal UC, and finally output the target drive signal UO through the full-bridge inverter circuit 200.

As shown in FIG. 2 and FIG. 4, when the buck-boost circuit 100 operates in the forward boost mode, the buck-boost circuit 100 may output a folded signal UC which has a voltage value being greater than the input voltage UI and has a positive voltage change slope. When the buck-boost circuit 100 operates in the reverse boost mode, the buck-boost circuit 100 may output a folded signal UC which has a voltage value being greater than the input voltage UI and has a negative voltage change slope. When the buck-boost circuit 100 operates in the forward buck mode, the buck-boost circuit 100 may output a folded signal UC which has a voltage value being less than the input voltage UI and has a positive voltage change slope. When the buck-boost circuit 100 operates in the reverse buck mode, the buck-boost circuit 100 may output a folded signal UC which has a voltage value being less than the input voltage UI and has a negative voltage change slope.

As shown in FIG. 4, the waveform of the target driving signal UO in this embodiment is a triangular wave. However, the waveform of the target driving signal UO may also be a square wave, a sine wave, or the like. The waveform of the target driving signal UO is not limited in this embodiment.

Compared with the conventional drive circuit 10, when the buck-boost circuit 100 in this embodiment operates in the reverse boost mode or the reverse buck mode, the current direction in the circuit is reversed, recovery of electric energy may also be realized, and a use efficiency of the electric energy is improved.

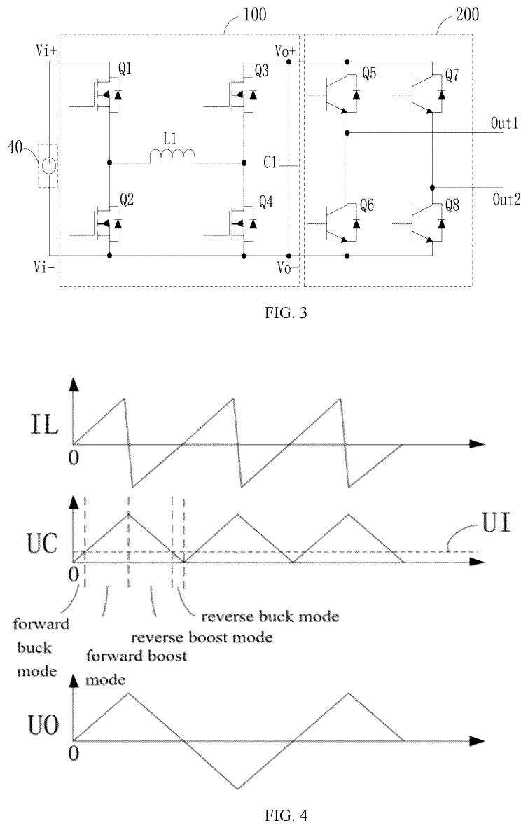

As shown in FIG. 1, FIG. 2, FIG. 3, and FIG. 4, in this embodiment, the buck-boost circuit 100 may be a Buck-Boost circuit having four switches. The buck-boost circuit 100 includes a first switching transistor Q1, a second switching transistor Q2, a third switching transistor Q3, a fourth switching transistor Q4, and a first inductor L1.

A first conductive terminal of the first switching transistor Q1 is connected to an input positive electrode Vi+ of the buck-boost circuit 100, a second conductive terminal of the first switching transistor Q1 is connected to a first conductive terminal of the second switching transistor Q2, and a second conductive terminal of the second switching transistor Q2 is connected to an input negative electrode Vi−, the input positive electrode Vi+ and the input negative electrode Vi− of the buck-boost circuit 100 are configured to receive the input voltage UI. In particular, the input positive electrode Vi+ is configured to be connected to a positive electrode of a power supply 40, the input negative electrode Vi− is configured to be connected to a negative electrode of a power supply 40, and the power supply 40 is configured to provide the input voltage UI. A first conductive terminal of the third switching transistor Q3 is connected to an output positive terminal Vc+ of the buck-boost circuit 100, a second conductive terminal of the third switching transistor Q3 is connected to a first conductive terminal of the fourth switching transistor Q4, and a second conductive terminal of the fourth switching transistor Q4 is connected to an output negative terminal Vc− of the buck-boost circuit 100. The control terminals of the first switching transistor Q1, the second switching transistor Q2, the third switching transistor Q3 and the fourth switching transistor Q4 are connected in common to the control circuit 300, in order to receive the control signal for voltage regulation. The first inductor L1 is connected between the second conductive terminal of the first switching transistor Q1 and the second conductive terminal of the third switching transistor Q3. In this embodiment, the input negative electrode Vi− and the output negative electrode Vc− are connected.

In particular, the first switching transistor Q1, the second switching transistor Q2, the third switching transistor Q3, and the fourth switching transistor Q4 are all N-channel metal oxide semiconductor (NMOS) transistors, a drain electrode of each NMOS transistor corresponds to the first conduction terminal, a source electrode of the NMOS transistor corresponds to the second conduction terminal, and a gate electrode of the NMOS transistor corresponds to the control terminal.

It should be noted that when the buck-boost circuit 100 operates in the forward boost mode and the reverse buck mode, the modulation control signal controls the first switching transistor Q1 and the second switching transistor Q2 to be complementarily switched-on, controls the third switching transistor Q3 to be switched-on, and controls the fourth switching transistor Q4 to be switched-off. By respectively configuring duty cycles of the modulation control signals transmitted to the first switching transistor Q1 and the second switching transistor Q2, such that the voltage modulation of the folded signal UC is achieved and the current direction in the first inductor L1 is changed.

When the buck-boost circuit 100 operates in the forward buck mode and the reverse boost mode, the modulation control signal controls the first switching transistor Q1 to be switched-on, controls the second switching transistor Q2 to be switched-off, and controls the third switching transistor Q3 and the fourth switching transistor Q4 to be complementarily switched-on. By respectively configuring the duty ratios of the modulation control signals transmitted to the third switching transistor Q3 and the fourth switching transistor Q4, such that the voltage modulation of the folded signal UC is realized and the current direction in the first inductor L1 is changed.

As compared to the existing bidirectional buck-boost circuit, a voltage stress applied to the first inductor L1 in this embodiment is smaller, and an inductor with low withstand voltage may be used to achieve the effects of cost conservation and reduction of chip area.

In this embodiment, the buck-boost circuit 100 further includes a first capacitor C1, the first capacitor C1 is connected between an output positive electrode Vc+ and an output negative electrode Vc− to keep the folded signal stable.

It should be noted that when the buck-boost circuit 100 in the present embodiment operates in a reverse boost mode or in a reverse buck mode, the current direction in the circuit is reversed, and the electric energy on the first capacitor C1 may be recycled to the power supply 40.

As shown in FIG. 2 and FIG. 3, in this embodiment, the full-bridge inverter circuit 200 includes a fifth switching transistor Q5, a sixth switching transistor Q6, a seventh switching transistor Q7, and an eighth switching transistor Q8. A first conductive terminal of the fifth switching transistor Q5 is connected to the output positive terminal Vc+, a second conductive terminal of the fifth switching transistor Q5 is connected to the first conductive terminal of the sixth switching transistor Q6 and is further connected to the first load terminal Out1, the second conductive terminal of the sixth switching transistor Q6 is connected to the output negative terminal Vc−. A first conductive terminal of the seventh switching transistor Q7 is connected to the output positive terminal Vc+, a second conductive terminal of the seventh switching transistor Q7 is connected to a first conductive terminal of the eighth switching transistor Q8 and is further connected to a second load terminal Out2, and a second conductive terminal of the eighth switching transistor Q8 is connected to the output negative terminal Vc−. Control terminals of the fifth switching transistor Q5, the sixth switching transistor Q6, the seventh switching transistor Q7, and the eighth switching transistor Q8 are connected to the control circuit 300 to receive the polarity inversion signal. The first load terminal Out1 and the second load terminal Out2 are configured to output the target driving signal UO.

Specifically, the fifth switching transistor Q5, the sixth switching transistor Q6, the seventh switching transistor Q7 and the eighth switching transistor Q8 are NPN type triodes, a collecting electrode of the NPN type triode corresponds to the first conductive terminal, the emitting electrode of the NPN type triode corresponds to the second conductive terminal, and a base electrode of the NPN type triode corresponds to the control terminal.

As shown in FIG. 2, FIG. 3, and FIG. 4, it should be noted that, due to the fact that the folded signal UC is an unipolar signal, assuming that when the polarity inversion signal controls the fifth switching transistor Q5 and the eighth switching transistor Q8 to be switched-on, and controls the sixth switching transistor Q6 and the seventh switching transistor Q7 to be switched-off, the voltage polarity between the first load terminal Out1 and the second load terminal Out2 is positive, when the polarity inversion signal controls the fifth switching transistor Q5 and the eighth switching transistor Q8 to be switched-off, and controls the sixth switching transistor Q6 and the seventh switching transistor Q7 to be switched-on, the voltage polarity between the first load terminal Out1 and the second load terminal Out2 is reversed. In this condition, the polarity of the voltage is negative, that is, the polarity of part of the folded signal UC is reversed. In this way, the unipolar folded signal UC may be converted into high-swing target driving signal UO by controlling switching-on and switching-off of the fifth switching transistor Q5, the sixth switching transistor Q6, the seventh switching transistor Q7 and the eighth switching transistor Q8.

As shown in FIG. 2 and FIG. 3, in this embodiment, the control circuit 300 includes a sampling subcircuit 310 and a control subcircuit 320 which are connected to each other. The sampling subcircuit 310 is connected to the buck-boost circuit 100, and is configured to collect the folded signal UC and collect an inductor current IL on the first inductor L1, and output the folded signal UC and the inductor current IL to the control subcircuit 320. The control subcircuit 320 is a proportional integral controller (PIC) and is configured to generate a control signal for voltage regulation and a polarity inversion signal according to a reference signal, and perform feedback control on the control signal for voltage regulation and the polarity inversion signal according to the folded signal UC and the inductive current I1. The control signal for voltage regulation and the polarity inversion signal are configured to respectively control the corresponding switching transistors to be switched-on or switched-off.

Specifically, the reference signal includes parameters including a waveform, a frequency, and a voltage amplitude of the target drive signal UO, and the control subcircuit 320 may output a corresponding control signal for voltage regulation and a corresponding polarity inversion signal according to the reference signal to generate the target drive signal UO at the first load terminal Out1 and the second load terminal Out2. Moreover, the control subcircuit 320 may further obtain a theoretical inductance current value and a theoretical voltage amplitude according to the reference signal, compare the theoretical inductance current value and the theoretical voltage amplitude with the collected inductance current IL and the collected folded signal UC, respectively, and then perform the feedback control on the control signal for voltage regulation and the polarity inversion signal, thereby changing an operating mode of the buck-boost circuit 100 when a magnitude relationship between the voltage value of the folded signal UC and the voltage value of the input voltage UI changes, and thereby reducing an error of the output target drive signal UO and improving an anti-interference capability.

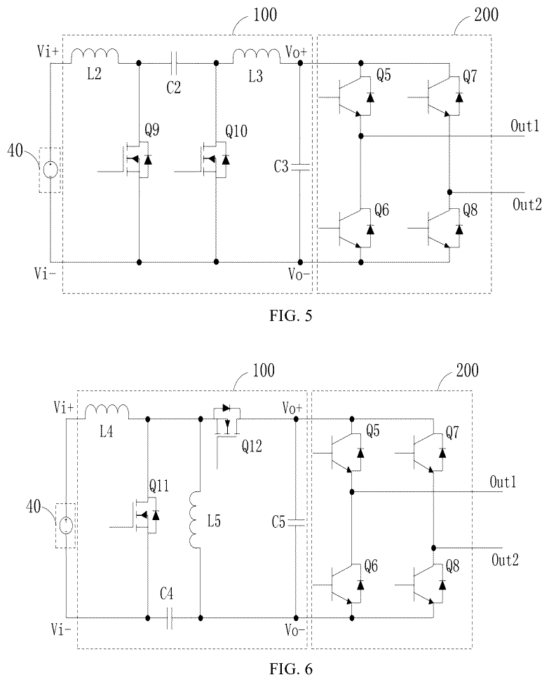

FIG. 5 illustrates a schematic circuit configuration of a drive circuit 10 provided in the second embodiment of the present application. For the convenience of illustration, the part associated with this embodiment is merely illustrated. The details of this part are described below:

Unlike the first embodiment, the buck-boost circuit 100 in this embodiment may be a bidirectional Cuk circuit, and the buck-boost circuit 100 includes a second inductor L2, a third inductor L3, a ninth switching transistor Q9, a tenth switching transistor Q10, a second capacitor C2, and a third capacitor C3. The second inductor L2, the second capacitor C2 and the third inductor L3 are sequentially connected in series between the input positive electrode Vi+ and the output positive electrode Vo+. A first conductive terminal of the ninth switching transistor Q9 is connected to a first end of the second inductor L2, and a second conductive terminal of the ninth switching transistor Q9 is connected to the input negative electrode Vi−. A first conductive terminal of the tenth switching transistor Q10 is connected to a second end of the second inductor L2, and a second conductive terminal of the tenth switching transistor Q10 is connected to the output negative electrode Vo−. The third capacitor C3 is connected between the output positive electrode Vo+ and the output negative electrode Vo−. The output negative electrode Vo− is connected to the input negative electrode Vi−.

Specifically, the ninth switching transistor Q9 and the tenth switching transistor Q10 are both NMOS transistors, a drain electrode of each NMOS transistor corresponds to the first conduction terminal, a source electrode of the NMOS transistor corresponds to the second conduction terminal, and a gate electrode of the NMOS transistor corresponds to the control terminal.

The control circuit 300 may output the corresponding control signal for voltage regulation to control the buck-boost circuit 100 in this embodiment to generate and output the folded signal UO.

As compared to the first embodiment, less transistors and more inductors and capacitors are used in this embodiment are less. Thus, control becomes more difficult.

FIG. 6 illustrates a circuit diagram of a drive circuit 10 provided in the third embodiment of the present application. For the convenience of illustration, the part associated with this embodiment is merely illustrated. The details of this part are described below:

Unlike any of the aforesaid embodiments, the buck-boost circuit 100 in this embodiment may be a bidirectional Sepic Zeta circuit. The buck-boost circuit 100 includes a fourth inductor L4, a fifth inductor L5, an eleventh switch Q11, a twelfth switch Q12, a fourth capacitor C4, and a fifth capacitor C5. The fourth inductor L4 is connected between the first conductive terminal of the eleventh switch Q11 and the input positive electrode Vi+, the second conductive terminal of the eleventh switch Q11 is connected to the input negative electrode Vi−. A first conductive terminal of the twelfth switch Q12 is connected to an output positive electrode Vo+, a second conductive terminal of the twelfth switch Q12 is connected to the first conductive terminal of the eleventh switch Q11, the fifth inductor L5 is connected between the second conductive terminal of the twelfth switch Q12 and the output negative electrode Vo−. The fourth capacitor C4 is connected between the input negative electrode Vi—and the output negative electrode Vo−, and the fifth capacitor C5 is connected between the output positive electrode Vo+ and the output negative electrode Vo−.

Specifically, the eleventh switch Q11 and the twelfth switch Q12 are both NMOS transistors, the drain electrode of the NMOS transistor corresponds to the first conducting terminal, the source electrode of the NMOS transistor corresponds to the second conducting terminal, and the gate electrode of the NMOS transistor corresponds to the control terminal.

The control circuit 300 may output corresponding control signal for voltage regulation to control the boost-buck circuit 100 in this embodiment to generate and output the folded signal UO.

As compared to the first embodiment, less transistors and more inductances and capacitors are used in this embodiment. Thus, control becomes more difficult.

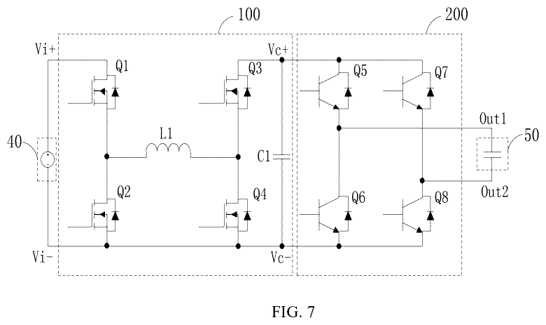

FIG. 7 illustrates a circuit configuration diagram of a piezoelectric actuator provided in the fourth embodiment of the present application. For the convenience of illustration, the parts associated with this embodiment is merely illustrated. The details of this part are described below:

As shown in FIGS. 1-7, the piezoelectric actuator includes an actuator circuit 50 and the drive circuit 10 according to any of the aforesaid embodiments. The first embodiment is used in the circuit configuration shown in FIG. 7, the full-bridge inverter circuit 200 is connected to the actuator circuit 50.

In this embodiment, the actuator circuit 50 is a capacitive actuator.

Specifically, the capacitive actuator may be a piezoelectric ceramic.

The person of ordinary skill in the art may clearly understand that, for the convenience of illustration and for conciseness, the dividing of the various functional units and functional modules is merely described according to examples. In an actual application, these functions may be assigned to different functional units and functional modules to be accomplished, that is, an inner structure of the device is divided into different functional units or modules to accomplish the whole or some of functionalities described above. The various functional units and modules in the embodiments may be integrated into a processing unit, or each of the units exists independently and physically, or two or more than two of the units are integrated into a single unit. In addition, specific names of the various functional units and modules are only used to be distinguished from each other conveniently, rather than being intended to limit the protection scope of the present application. Regarding the specific operating process of the units and modules in the system, reference may be made to a corresponding process in the aforementioned method embodiments. This specific operating process of the units and modules is not repeatedly described herein.

In the aforesaid embodiments, the descriptions of the various embodiments are emphasized respectively, regarding a part of one embodiment which has not been described or disclosed in detail, reference can be made to relevant descriptions in other embodiments.

The foregoing embodiments are only intended to explain the technical solutions of the present application, rather than limiting the technical solutions of the present application. Although the present application has been described in detail with reference to these embodiments, a person of ordinary skilled in the art should understand that, the technical solutions disclosed in the embodiments may also be amended, some technical features in the technical solutions may also be equivalently replaced. The amendments or the equivalent replacements don't cause the essence of the corresponding technical solutions to be deviated from the spirit and the scope of the technical solutions in the embodiments of the present application, and thus should all be included in the protection scope of the present application.

1. A drive circuit, comprising:
a buck-boost circuit configured to operate in a corresponding voltage regulation mode according to a control signal for voltage regulation, so as to convert an input voltage into an unipolar folded signal and output the folded signal, wherein the voltage regulation mode comprises a forward boost mode, a reverse boost mode, a forward buck mode, and a reverse buck mode;
a full-bridge inverter circuit connected to the buck-boost circuit and configured to invert polarities of part of the folded signal according to a polarity inversion signal, in order to expand the folded signal into a target drive signal and output the target drive signal; and
a control circuit connected to the buck-boost circuit and the full-bridge inverter circuit and configured to generate the control signal for voltage regulation and the polarity inversion signal according to a reference signal, wherein the reference signal corresponds to the target drive signal.

2. The drive circuit according to claim 1, wherein the buck-boost circuit comprises a first switching transistor, a second switching transistor, a third switching transistor, a fourth switching transistor and a first inductor;
a first conductive terminal of the first switching transistor is connected to an input positive electrode of the buck-boost circuit, a second conductive terminal of the first switching transistor is connected to a first conductive terminal of the second switching transistor, and a second conductive terminal of the second switching transistor is connected to an input negative electrode of the buck-boost circuit; wherein both the input positive electrode and the input negative electrode are configured to receive the input voltage;
a first conductive terminal of the third switching transistor is connected to an output positive electrode of the buck-boost circuit, a second conductive terminal of the third switching transistor is connected to a first conductive terminal of the fourth switching transistor, and a second conductive terminal of the fourth switching transistor is connected to an output negative electrode of the buck-boost circuit; control terminals of the first switching transistor, the second switching transistor, the third switching transistor and the fourth switching transistor are connected in common to the control circuit, in order to receive the control signal for voltage regulation;
the first inductor is connected between the second conductive terminal of the first switching transistor and the second conductive terminal of the third switching transistor; and
the input negative electrode is connected to the output negative electrode.

3. The drive circuit according to claim 2, wherein the buck-boost circuit further comprises a first capacitor connected between the output positive electrode and the output negative electrode.

4. The drive circuit according to claim 2, wherein when the buck-boost circuit is operated in the forward boost mode and the reverse buck mode according to the control signal for voltage regulation, the first switching transistor remains in a switched-on state, the second switching transistor remains in a switched-off state, the third switching transistor and the fourth switching transistor are complementarily switched-on.

5. The drive circuit according to claim 2, wherein when the buck-boost circuit operates in the forward buck mode and the reverse boost mode according to the control signal for voltage regulation, the first switching transistor and the second switching transistor are complementarily switched-on, the third switching transistor remains in a switched-on state, and the fourth switching transistor remains in a switched-off state.

6. The drive circuit according to claim 2, wherein the full-bridge inverter circuit comprises a fifth switching transistor, a sixth switching transistor, a seventh switching transistor and an eighth switching transistor;
a first conductive terminal of the fifth switching transistor is connected to the output positive electrode of the buck-boost circuit, a second conductive terminal of the fifth switching transistor is connected to a first conductive terminal of the sixth switching transistor and is further connected to a first load terminal, and a second conductive terminal of the sixth switching transistor is connected to the output negative electrode of the buck-boost circuit; and
a first conductive terminal of the seventh switching transistor is connected to the output positive electrode of the buck-boost circuit, a second conductive terminal of the seventh switching transistor is connected to a first conductive terminal of the eighth switching transistor and is connected to a second load terminal, and a second conductive terminal of the eighth switching transistor is connected to the output negative electrode of the buck-boost circuit; control terminals of the fifth switching transistor, the sixth switching transistor, the seventh switching transistor, and the eighth switching transistor are connected in common to the control circuit, in order to receive the polarity inversion signal; wherein the first load terminal and the second load terminal are configured to output the target drive signal.

7. The drive circuit according to claim 1, wherein the control circuit comprises a sampling subcircuit and a control subcircuit which are interconnected;
the sampling subcircuit is connected to the buck-boost circuit, and is configured to collect the folded signal and a sampling current flowing through the buck-boost circuit, and output the folded signal and the sampling current to the control subcircuit;
the control subcircuit is connected to the buck-boost circuit and the full-bridge inverter circuit, and is configured to generate the control signal for voltage regulation and the polarity inversion signal according to the reference signal, and perform a feedback control on the control signal for voltage regulation and the polarity inversion signal according to the folded signal and the sampling current; and
the control signal for voltage regulation and the polarity inversion signal are configured to respectively control a corresponding switching transistor to be switched-on or be switched-off.

8. The drive circuit according to claim 1, wherein the buck-boost circuit comprises a second inductor, a third inductor, a ninth switching transistor, a tenth switching transistor, a second capacitor, and a third capacitor;
the second inductor, the second capacitor and the third inductor are sequentially connected in series between an input positive electrode of the buck-boost circuit and an output positive electrode of the buck-boost circuit;
a first conductive terminal of the ninth switching transistor is connected to a first end of the second inductor, and a second conductive terminal of the ninth switching transistor is connected to an input negative electrode of the buck-boost circuit;
a first conductive terminal of the tenth switching transistor is connected to a second end of the second inductor, and a second conductive terminal of the tenth switching transistor is connected to an output negative electrode of the buck-boost circuit; and
the third capacitor is connected between the output positive electrode and the output negative electrode, and the output negative electrode is connected to the input negative electrode.

9. The drive circuit according to claim 1, wherein the buck-boost circuit comprises a fourth inductor, a fifth inductor, an eleventh switching transistor, a twelfth switching transistor, a fourth capacitor, and a fifth capacitor;
the fourth inductor is connected between a first conductive terminal of the eleventh switching transistor and an input positive electrode of the buck-boost circuit, and a second conductive terminal of the eleventh switching transistor is connected to an input negative electrode of the buck-boost circuit;
a first conductive terminal of the twelfth switching transistor is connected to an output positive electrode of the buck-boost circuit, a second conductive terminal of the twelfth switching transistor is connected to the first conductive terminal of the eleventh switching transistor, and the fifth inductor is connected between the second conductive terminal of the twelfth switching transistor and an output negative electrode of the buck-boost circuit; and
the fourth capacitor is connected between the input negative electrode and the output negative electrode, and the fifth capacitor is connected between the output positive electrode and the output negative electrode.

10. A piezoelectric actuator, comprising an actuator circuit and a drive circuit;
wherein the drive circuit comprises:
a buck-boost circuit configured to operate in a corresponding voltage regulation mode according to a control signal for voltage regulation, so as to convert an input voltage into an unipolar folded signal and output the folded signal, wherein the voltage regulation mode comprises a forward boost mode, a reverse boost mode, a forward buck mode, and a reverse buck mode;
a full-bridge inverter circuit connected to the buck-boost circuit and configured to invert polarities of part of the folded signal according to a polarity inversion signal, in order to expand the folded signal into a target drive signal and output the target drive signal; and
a control circuit connected to the buck-boost circuit and the full-bridge inverter circuit and configured to generate the control signal for voltage regulation and the polarity inversion signal according to a reference signal, wherein the reference signal corresponds to the target drive signal.
wherein the full-bridge inverter circuit is connected to the actuator circuit, and the actuator circuit is a capacitive actuator.

11. The piezoelectric actuator according to claim 10, wherein the buck-boost circuit comprises a first switching transistor, a second switching transistor, a third switching transistor, a fourth switching transistor and a first inductor;
a first conductive terminal of the first switching transistor is connected to an input positive electrode of the buck-boost circuit, a second conductive terminal of the first switching transistor is connected to a first conductive terminal of the second switching transistor, and a second conductive terminal of the second switching transistor is connected to an input negative electrode of the buck-boost circuit; wherein both the input positive electrode and the input negative electrode are configured to receive the input voltage;
a first conductive terminal of the third switching transistor is connected to an output positive electrode of the buck-boost circuit, a second conductive terminal of the third switching transistor is connected to a first conductive terminal of the fourth switching transistor, and a second conductive terminal of the fourth switching transistor is connected to an output negative electrode of the buck-boost circuit; control terminals of the first switching transistor, the second switching transistor, the third switching transistor and the fourth switching transistor are connected in common to the control circuit, in order to receive the control signal for voltage regulation;
the first inductor is connected between the second conductive terminal of the first switching transistor and the second conductive terminal of the third switching transistor; and
the input negative electrode is connected to the output negative electrode.

12. The piezoelectric actuator according to claim 11, wherein the buck-boost circuit further comprises a first capacitor connected between the output positive electrode and the output negative electrode.

13. The piezoelectric actuator according to claim 11, wherein when the buck-boost circuit is operated in the forward boost mode and the reverse buck mode according to the control signal for voltage regulation, the first switching transistor remains in a switched-on state, the second switching transistor remains in a switched-off state, the third switching transistor and the fourth switching transistor are complementarily switched on.

14. The piezoelectric actuator according to claim 12, wherein when the buck-boost circuit is operated in the forward boost mode and the reverse buck mode according to the control signal for voltage regulation, the first switching transistor remains in a switched-on state, the second switching transistor remains in a switched-off state, the third switching transistor and the fourth switching transistor are complementarily switched-on.

15. The piezoelectric actuator according to claim 11, wherein when the buck-boost circuit operates in the forward buck mode and the reverse boost mode according to the control signal for voltage regulation, the first switching transistor and the second switching transistor are complementarily switched-on, the third switching transistor remains in a switched-on state, and the fourth switching transistor remains in a switched-off state.

16. The piezoelectric actuator according to claim 12, wherein when the buck-boost circuit operates in the forward buck mode and the reverse boost mode according to the control signal for voltage regulation, the first switching transistor and the second switching transistor are complementarily switched-on, the third switching transistor remains in a switched-on state, and the fourth switching transistor remains in a switched-off state.

17. The piezoelectric actuator according to claim 11, wherein the full-bridge inverter circuit comprises a fifth switching transistor, a sixth switching transistor, a seventh switching transistor and an eighth switching transistor;
a first conductive terminal of the fifth switching transistor is connected to the output positive electrode of the buck-boost circuit, a second conductive terminal of the fifth switching transistor is connected to a first conductive terminal of the sixth switching transistor and is further connected to a first load terminal, and a second conductive terminal of the sixth switching transistor is connected to the output negative electrode of the buck-boost circuit; and
a first conductive terminal of the seventh switching transistor is connected to the output positive electrode of the buck-boost circuit, a second conductive terminal of the seventh switching transistor is connected to a first conductive terminal of the eighth switching transistor and is connected to a second load terminal, and a second conductive terminal of the eighth switching transistor is connected to the output negative electrode of the buck-boost circuit; control terminals of the fifth switching transistor, the sixth switching transistor, the seventh switching transistor, and the eighth switching transistor are connected in common to the control circuit, in order to receive the polarity inversion signal; wherein the first load terminal and the second load terminal are configured to output the target drive signal.

18. The piezoelectric actuator according to claim 10, wherein the control circuit comprises a sampling subcircuit and a control subcircuit which are interconnected;
the sampling subcircuit is connected to the buck-boost circuit, and is configured to collect the folded signal and a sampling current flowing through the buck-boost circuit, and output the folded signal and the sampling current to the control subcircuit;
the control subcircuit is connected to the buck-boost circuit and the full-bridge inverter circuit, and is configured to generate the control signal for voltage regulation and the polarity inversion signal according to the reference signal, and perform a feedback control on the control signal for voltage regulation and the polarity inversion signal according to the folded signal and the sampling current; and
the control signal for voltage regulation and the polarity inversion signal are configured to respectively control a corresponding switching transistor to be switched-on or be switched-off.

19. The piezoelectric actuator according to claim 10, wherein the buck-boost circuit comprises a second inductor, a third inductor, a ninth switching transistor, a tenth switching transistor, a second capacitor, and a third capacitor;
the second inductor, the second capacitor and the third inductor are sequentially connected in series between an input positive electrode of the buck-boost circuit and an output positive electrode of the buck-boost circuit;
a first conductive terminal of the ninth switching transistor is connected to a first end of the second inductor, and a second conductive terminal of the ninth switching transistor is connected to an input negative electrode of the buck-boost circuit;
a first conductive terminal of the tenth switching transistor is connected to a second end of the second inductor, and a second conductive terminal of the tenth switching transistor is connected to an output negative electrode of the buck-boost circuit; and
the third capacitor is connected between the output positive electrode and the output negative electrode, and the output negative electrode is connected to the input negative electrode.

20. The piezoelectric actuator according to claim 10, wherein the buck-boost circuit comprises a fourth inductor, a fifth inductor, an eleventh switching transistor, a twelfth switching transistor, a fourth capacitor, and a fifth capacitor;
the fourth inductor is connected between a first conductive terminal of the eleventh switching transistor and an input positive electrode of the buck-boost circuit, and a second conductive terminal of the eleventh switching transistor is connected to an input negative electrode of the buck-boost circuit;
a first conductive terminal of the twelfth switching transistor is connected to an output positive electrode of the buck-boost circuit, a second conductive terminal of the twelfth switching transistor is connected to the first conductive terminal of the eleventh switching transistor, and the fifth inductor is connected between the second conductive terminal of the twelfth switching transistor and an output negative electrode of the buck-boost circuit; and
the fourth capacitor is connected between the input negative electrode and the output negative electrode, and the fifth capacitor is connected between the output positive electrode and the output negative electrode.
